(19) United States
(12) Patent Application Publication
(10) Pub. No.: US 2016/0378429 A1
(43) Pub. Date: Dec. 29, 2016

(54) AUDIO SYSTEMS AND RELATED METHODS AND DEVICES

(71) Applicant: Bose Corporation, Framingham, MA (US)

(72) Inventor: Eric E. Dolecki, Framingham, MA (US)

(73) Assignee: Bose Corporation, Framingham, MA (US)

(21) Appl. No.: 15/262,386

(22) Filed: Sep. 12, 2016

Related U.S. Application Data
(62) Division of application No. 14/313,648, filed on Jun. 24, 2014.

(51) Int. Cl. G06F 3/16; H04R 3/12; G06F 1/16; G08C 17/02

(52) U.S. Cl. CPC G06F 3/165; G08C 17/02; H04R 3/12; G06F 1/163; H04R 2227/005; G08C 2201/91; H04R 2430/01

(57) ABSTRACT

A wearable remote control device can be beneficially incorporated into an audio system to provide for added functionality. For example, a wearable remote control device may help to enable, among other things, voice control functionality, predictive playback functionality, voice control functionality, gesture input functionality, and transitioning audio among a plurality of audio playback devices.

### BACKGROUND

This disclosure relates to audio systems and related methods and devices, and, particularly, to an audio system that includes a wearable remote control device for controlling operation of one or more audio playback devices.

### SUMMARY

All examples and features mentioned below can be combined in any technically possible way.

In one aspect, an audio system includes an audio playback device configured to operably connect to a plurality of digital audio sources, and a wearable remote control device for controlling operation of the audio playback device. The wearable remote control device includes a transmitter for transmitting a signal, and a controller coupled to the transmitter for controlling the transmission of the signal. The audio playback device includes a digital-to-analog converter configured to receive a digital representation of content from the digital audio sources and convert to analog form; an electro-acoustic transducer; a communication interface; and a processor coupled to the digital-to-analog converter, the electro-acoustic transducer, and the communication interface. The audio playback device also includes instructions stored on a non-transitory computer-readable media that, when executed, cause the processor to: to receive the signal from the transmitter of the wearable remote control device via the communication interface; and detect a presence of the wearable device in proximity to the audio playback device based on the signal received from the wearable remote control device via the communication interface, and, in response to detecting the presence of the wearable device, to automatically initiate rendering of audio content via the digital-to-analog converter and the electro-acoustic transducer.

Implementations may include one of the following features, or any combination thereof.

In some implementations, the instructions, when executed, cause the processor to detect a change in proximity of the wearable remote control device; and to adjust a volume of audio content being rendered on the audio playback device based on the change in proximity of the wearable device to the audio playback device.

In certain implementations, the instructions, when executed, cause the processor to increase the volume of audio content being rendered on the audio playback device when the wearable device is moved closer to the audio playback device.

In some cases, the instructions, when executed, cause the processor to decrease the volume of audio content being rendered on the audio playback device when the wearable device is moved away from the audio playback device.

In certain cases, the audio playback device is configured to determine a proximity of the wearable device based on a strength of the signal received from the wearable device.

In some examples, the audio playback device is configured to determine a proximity of the wearable device via Bluetooth low energy (Bluetooth LE) proximity sensing.

In certain examples, the wearable remote control device includes buttons which are operable to adjust volume on the audio playback device.

In some implementations, the wearable remote control device is configured to be worn on a wrist of a user.

In certain implementations, the audio playback device includes a set of user-selectable preset indicators. Each indicator in the set of preset indicators is configured to have assigned to it an entity associated with the plurality of digital audio sources, and the wearable remote control device is operable to select presets on the audio playback device for playback of audio content associated with a selected one of the presets.

In another aspect, a method includes automatically transitioning playback of streamed audio content from a first audio playback device to a second audio playback device as the wearable remote control device is moved from a first position that is closer to first audio playback device than to the second audio playback device toward to a second position that is closer to the second audio playback device than to the first audio playback device.

Implementations may include one of the above and/or below features, or any combination thereof.

In some implementations, automatically transitioning playback of the streamed audio content includes gradually reducing volume of audio content rendered via the first audio playback device as the wearable device is moved away from the first audio playback device, and gradually increasing the volume of audio content rendered via the second audio playback device as the wearable remote control device is moved closer to the second audio playback device.

In certain implementations, the first audio playback device is configured to detect a presence of the wearable device in proximity to the first audio playback device, and, automatically transitioning playback of the streamed audio content includes automatically decreasing the volume of audio content being played on the first audio playback device when a detected proximity of the wearable remote control device to the first audio playback device decreases.

In some cases, automatically transitioning playback of the audio content includes ceasing playback of the audio content on the first audio playback device when the detected proximity of the wearable remote control device to the first audio playback device falls below a threshold value.

In certain cases, automatically transitioning includes sending information regarding the audio content from the wearable remote control device to the second audio playback device.

In some examples, the information regarding the audio content includes an identification of an entity for providing audio content.

Another aspect features a wearable remote control device for controlling operation of an audio playback device. The wearable remote control device includes a transmitter; one or more sensors; and a controller. The wearable remote control device also includes instructions stored on a non-transitory computer-readable media that, when executed, cause the controller to: detect gesture input from a user via the one or more sensors, the gesture input including a pattern traced by the user; associate the gesture input with a command; and send a command signal to an audio playback device via the transmitter for execution of the associated command.

Implementations may include one of the above and/or below features, or any combination thereof.

In some implementations, the wearable remote control device includes a touch surface, and the gesture input includes a pattern traces on the touch surface.

In certain implementations, the wearable remote control device includes a plurality of force sensors, and the instructions cause the controller to detect the gesture input by sensing localized displacement of the touch surface.

In some cases, the wearable remote control device includes a capacitive sensor, and the instructions cause the controller to detect the gesture input by sensing changes in capacitance as a user traces a pattern on the touch surface.

In certain cases, the wearable remote control device also includes an orientation sensor and an acceleration sensor, and the instructions cause the controller to detect the gesture input by sensing movements of the wearable remote control device via the orientation and acceleration sensors.

In some examples, the wearable remote control device is incorporated in an audio system that also includes an audio playback device that is configured to operably connect to a plurality of digital audio sources.

In certain examples, the associated command is a selection of a preset, and, in response to receiving the command signal, the audio playback device is configured to render audio content from an entity associated with the selected preset.

Another aspect provides a wearable remote control device for controlling operation of an audio playback device. The wearable remote control device includes a transmitter; a microphone; and a controller coupled to the microphone and the transmitter. The wearable remote control device also includes instructions stored on a non-transitory computer-readable media that, when executed, cause the controller to: receive voice input from a user via the microphone; record the voice input in an audio file; and send the audio file to the audio playback device via the transmitter.

Implementations may include one of the above and/or below features, or any combination thereof.

In some implementations, the wearable remote control device is incorporated in a system that also includes the audio playback device. The audio playback device includes a digital-to-analog converter configured to receive a digital representation of content from the digital audio sources and convert to analog form; an electro-acoustic transducer; a communication interface; and a processor coupled to the digital-to-analog converter, the electro-acoustic transducer, and the communication interface. The audio playback device also includes instructions stored on a non-transitory computer-readable media that, when executed, cause the processor to: receive the audio file via the communication interface; associate the recorded voice input with a command; and execute the associated command.

In yet another aspect, an audio system includes an audio playback device configured to operably connect to a plurality of digital audio sources; and a wearable remote control device for controlling operation of the audio playback device. The audio playback device includes a digital-to-analog converter configured to receive a digital representation of content from the digital audio sources and convert to analog form; a first electro-acoustic transducer; a communication interface; and a processor coupled to the digital-to-analog converter, the electro-acoustic transducer, and the communication interface. The audio playback device also include instructions stored on a non-transitory computer-readable media that, when executed, cause the processor to: receive streamed audio content from the audio source via the communication interface; and re-stream the audio content to the wearable remote control device via the communication interface. The wearable remote control device includes a receiver; a second electro-acoustic transducer; and a controller. The wearable remote control device also includes instructions stored on a non-transitory computer-readable media that, when executed, cause the controller to: receive the re-streamed audio content from the audio playback device via the receiver; and render the audio content via the digital-to-analog converter and the electro-acoustic transducer.

Implementations may include one of the above and/or below features, or any combination thereof.

According to another aspect, a wearable remote control device is provided for controlling operation of an audio playback device. The wearable remote control device includes a receiver; a first electro-acoustic transducer; and a controller coupled to the receiver and the first electro-acoustic transducer. The wearable remote control device also includes instructions stored on a non-transitory computer-readable media that, when executed, cause the controller to: receive the alarm signal from an audio playback device via the receiver; and in response to receiving the alarm signal, trigger an alarm.

Implementations may include one of the above and/or below features, or any combination thereof.

In some implementations, the instructions cause the controller to trigger an audible alarm via the first electro-acoustic transducer.

In certain implementations, the wearable remote control device includes a vibrating motor, and the instructions cause the control to trigger a vibrating alarm via vibrating motor.

In some cases, the wearable remote control device is incorporated in an audio system with an audio playback device that is configured to operably connect to a plurality of digital audio sources. The audio playback device includes a digital-to-analog converter configured to receive a digital representation of content from the digital audio sources and convert to analog form; a first electro-acoustic transducer; a communication interface; and a processor coupled to the digital-to-analog converter, the electro-acoustic transducer, and the communication interface. The audio playback device also includes instructions stored on a non-transitory computer-readable media that, when executed, cause the processor to: receive input corresponding to a command to set an alarm to be triggered at a specified time; and send an alarm signal to the wearable remote control device via the communication interface at the specified time.

### BRIEF DESCRIPTION OF THE DRAWINGS

FIG. 1 is a schematic view of an audio system that includes a wearable remote control device for controlling operation of one or more audio playback devices.

FIG. 2 is a swim lane diagram showing steps for the automatic initiation of playback of audio content in response to a detected presence of a wearable remote control device within the audio system of FIG. 1.

FIGS. 3A through 3C show a swim lane diagram illustrating steps for transitioning audio content between audio playback devices within the audio system of FIG. 1.

FIG. 4 is a swim lane diagram illustrating steps for implementing voice control within the audio system of FIG. 1

FIG. 5 is a swim lane diagram illustrating steps for implementing gesture recognition functionality within the audio system of FIG. 1.

FIG. 6 is a swim lane diagram illustrating steps for the streaming of audio content to the wearable remote control device within the audio system of FIG. 1.

FIGS. 7A and 7B are perspective and top plan views, respectively, of an exemplary audio playback device from the audio system of FIG. 1.

FIG. 7C is a block diagram of the audio playback device of FIG. 7A.

FIGS. 8A and 8B are front and side views of the wearable remote control device of FIG. 1.

FIG. 8C is a block diagram of the wearable remote control device of FIG. 8A.

FIG. 9 is a front view of an implementation of an audio playback device which includes a display.

FIG. 10 is a swim lane diagram illustrating steps for implementing alarm clock functionality within the audio system of FIG. 1.

### DETAILED DESCRIPTION

This disclosure is based, at least in part, on the realization that a wearable remote control device can be beneficially incorporated into an audio system to provide for added functionality. For example, a wearable remote control device may help to enable, among other things, voice control functionality, predictive playback functionality, voice control functionality, gesture input functionality, and transitioning audio among a plurality of audio playback devices.

System Overview

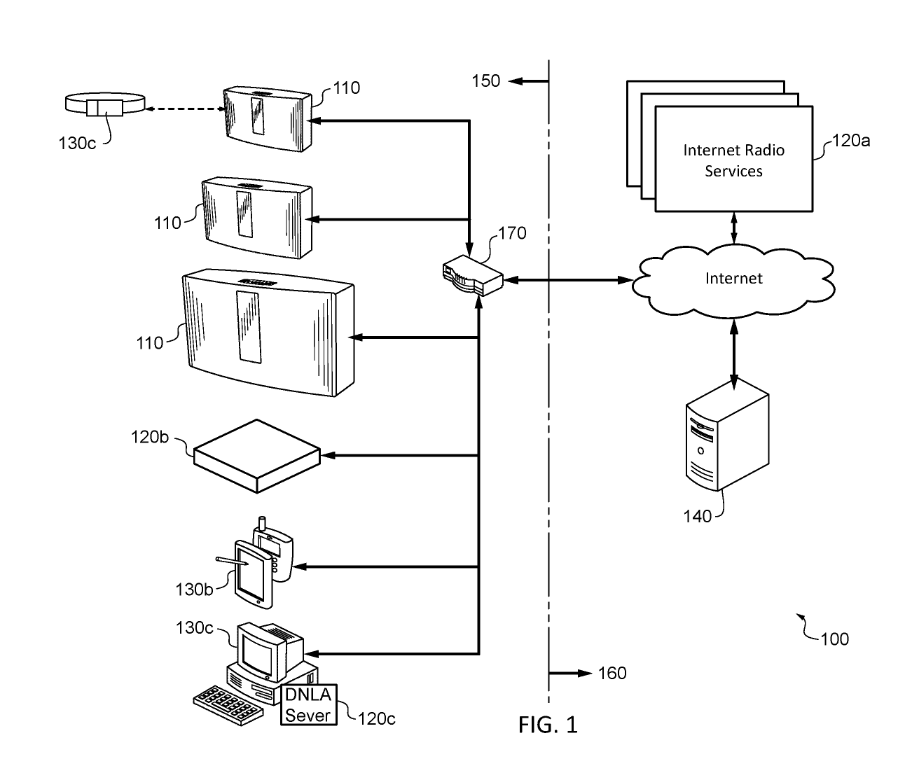

Referring to FIG. 1, an audio system 100 for the delivery of digital audio (e.g., digital music) includes four main categories of devices: (i) audio playback devices 110; (ii) digital audio sources 120a, 120b, 120c (collectively referenced as 120); control devices 130a, 130b, 130c (collectively referenced as 130); and a server 140.

The audio playback devices 110 are electronic devices which are capable of rendering audio content. These devices can access stored audio content (e.g., remotely stored audio content) and stream it for playback. In some cases, the audio playback devices 110 may also be capable of playing locally stored content. These devices render audio with the help of audio codecs and digital signal processors (DPSs) available within.

The audio playback devices 110 can communicate with each other. For example, each audio playback device 100 can communicate with the other audio playback devices 110 within the audio system 100 for synchronization. This can be a synchronization of device settings, such as synchronization of preset assignments, or, for synchronization of playback (e.g., such that all or a subset of the audio playback devices 110 play the same content simultaneously and synchronously).

The digital audio sources 120 are devices and/or services that provide access to one or more associated entities for supplying content (e.g., audio streams) to the audio playback devices 110, and which can be located remotely from the audio playback devices 110. An “Entity,” as used herein, refers to a grouping or collection of content for playback. Exemplary entities include Internet radio stations and user defined playlists. “Content” is data (e.g., an audio track) for playback. “Associated entity” refers to an entity that is associated with a particular audio source. For example, if the digital audio source 120 is an Internet music service such as Pandora, an example associated entity would be a radio station provided by Pandora®.

For the purposes of the audio system 100, audio streams are considered to be data. They are processed as digital information that is converted to analog before presentation. Data streaming is the method by which data is moved from an audio source 120 to an audio playback device 110. Typically, there are two models for this data movement, push and pull. The audio system 100 is capable of managing this audio (data) streaming in both fashions; descriptions of these processes are as follows.

In a push model, the digital audio source 120 will move the data to the audio playback device 110 at a pace that it desires. The recipient (e.g., one of the audio playback devices 110) of the data will acknowledge the data and the digital audio source 120 will provide more data. This model requires the digital audio source 120 to be managing the throughput characteristics of the audio system 100. In a pull model, the audio playback device 110 will request data from the digital audio source 120 at a rate it desires. This allows the audio playback device 110 to read ahead if data is available.

The digital audio sources 120 each maintain a repository of audio content which can be chosen by the user to play. The digital audio sources 120 are based on the Digital Living Network Alliance® (DLNA) or other Web based protocols similar to the Hypertext Transfer Protocol (HTTP). Some of the devices and services in this category include Internet based music services 120a such as Pandora®, Spotify®, and vTuner®; network-attached storage (NAS) devices 120b, and a media server daemon 120c (e.g., provided as a component of a computer-based controller).

The digital audio sources 120 include user defined playlists of digital music files available from network audio sources such as network-attached storage (NAS) devices 120b, and a DLNA server 120c which may be accessible to the audio playback devices 110 over a local area network such as a wireless (Wi-Fi) or wired (Ethernet) home network 150, as well as Internet music service 120a such as Pandora®, vTuner®, Spotify®, etc., which are accessible to the audio playback devices 110 over a wide area network 160 such as the Internet.

The control devices 130 are responsible for controlling the audio playback devices 110 and for browsing the audio sources 120 in the audio system 100. Some of the devices in this category include desktop computers, laptop computers, and mobile devices such as smart phones and tablets. These devices control the audio playback devices 110 via a wireless communication interface (e.g., IEEE 802.11 b/g, Bluetooth LE, infrared, etc.). The control devices 130 serve as an online management tool for a user's network enabled audio playback devices 110. The control devices 130 provide interfaces which enable to the user to perform one or more of the following: setup a connection to a Wi-Fi network; create an audio system account for the user, sign into a user's audio system account and retrieve information; add or remove an audio playback device 110 on a user's audio system account; edit an audio playback device's name, and update software; access the audio sources (via the audio playback devices 110); assign an entity (e.g., a playlist or radio station) associated with one of the audio sources 120 to a preset indicator; browse and select recents, where “recents” refers to recently accessed entities; use transport controls (play/pause, next/skip, previous), view “Now Playing” (i.e., content currently playing on an audio playback device 110) and album art; and adjust volume levels.

In some cases, the control devices 130 may include network control devices 130a, 130b and a wearable remote control device 130c. The network control devices 130a, 130b are control devices that communicate with the audio playback devices 110 over a wireless (Wi-Fi) network connection. The network control devices can include a primary network control device 130a and a secondary network control device 130b. The primary network control device 130a can be utilized for: connecting an audio playback device 110 to a Wi-Fi network (via a USB connection between the audio playback device 110 and the primary network control device 130a); creating a system account for the user; setting up music services; browsing of content for playback; setting preset assignments on the audio playback devices 110; transport control (e.g., play/pause, fast forward/rewind, etc.) for the audio playback devices 110; and selecting audio playback devices 110 for content playback (e.g., single room playback or synchronized multi-room playback). Devices in the primary network control device category can include desktop and laptop computers.

The secondary network control device 130b may offer some, but not all, of the functions of the primary network control device 130a. For example, the secondary network control device 130b may not provide for all of the account setup and account management functions that are offered by the primary network control device 130a. The secondary network control device 130b may be used for: music services setup; browsing of content; setting preset assignments on the audio playback devices; transport control of the audio playback devices; and selecting audio playback devices 110 for content playback: single room or synchronized multi-room playback. Devices in the secondary network control device category can include mobile devices such as smart phones and tablets.

The wearable remote control device 130c communicates wirelessly (e.g., via Bluetooth low energy (BTLE)) with the audio playback devices (item 110, FIG. 1). The wearable remote control device 130c may be used for: transport control (play/pause, etc.) of an associated (“paired”) audio playback device; and selecting presets on an associated audio playback device 110. Presets are a set of (e.g., six) user-defined shortcuts to content, intended to provide quick access to entities associated with the digital music sources 120 from (1 of 6) preset indicators present on each of the audio playback devices 110.

The server 140 is a cloud-based server which contains (e.g., within an account database) information related to a user's audio system account. This includes user account information such as the list of the audio playback devices 110 within the system 100, device diagnostic information, preset assignments, etc. The server 140 will be connected to by the audio playback devices 140 and by the control devices 130 (e.g., by primary network control device) for the purpose of preset management, as well as management of audio sources 120 and management of the user's audio system account. Generally, the control devices 130 (e.g., network control devices 130a, 130b) will login to the server 140 with a user's login details and ‘sync down’ the required information to work with.

The audio playback devices 110 and one or more of the control devices 130 are coupled to a local area network (LAN) 150. Other devices such as one or more of the digital audio sources (e.g., a network-attached storage (NAS) device 120b) may also be coupled to the LAN 150. The LAN 150 may be a wired network, a wireless network, or a combination thereof. In one example, the devices (e.g., audio playback devices 110 and control devices 130 (e.g., primary and secondary control devices 130a, 130b)) within the LAN 150 are wirelessly coupled to the LAN 150 based on an industry standard such as IEEE 802.11 b/g. The LAN 150 may represent a network within a home, an office, or a vehicle. In the case of a residential home, the audio playback devices 110 may be arranged in different rooms (e.g., kitchen, dining room, basement, etc.) within the home. The devices within the LAN 150 connect to a user supplied access point 170 (e.g., a router) and subsequently to a wide area network (WAN) 160 (e.g., the Internet) for communication with the other digital audio sources 120 (Internet based music services 120a) and the server 140.

Predictive Playback

In some instances, the audio playback devices may be configured to detect the presence of the wearable remote control, and, in response to detecting the presence of the wearable remote control device, to automatically initiate playback (rendering) of audio content. For example, a user may have one of the audio playback devices arranged within the kitchen of their home. The audio playback device may detect the presence of the user, wearing the wearable remote control device, entering the kitchen and may automatically initiate playback of audio content.

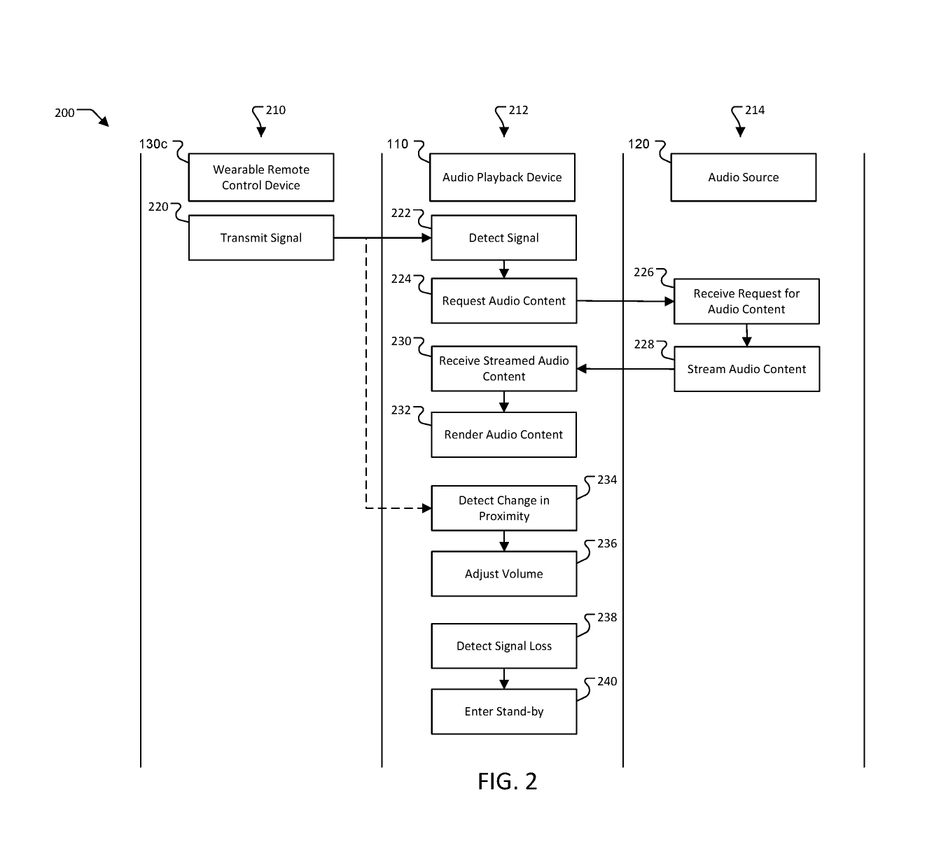

FIG. 2 is a swim lane diagram 200 showing steps for the automatic initiation of playback of audio content in response to a detected presence of a wearable remote control device 130c. “Swim lane” diagrams may be used to show the relationship between the various “actors” in the processes and to define the steps involved in the processes. FIG. 2 (and all other swim lane Figures) may equally represent a high-level block diagram of components of the invention implementing the steps thereof. The steps of FIG. 2 (and all the other FIGS. employing swim lane diagrams) may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network.

Referring to FIG. 2, three swim lanes are shown including a lane 210 for the wearable remote control device 130c, a lane 212 for one of the audio playback devices 110, and a lane 214 for one of the sources 120. At step 220, the wearable remote control device 130c transmits a signal that is detectable by the audio playback device 110.

At step 222, the audio playback device 110 detects a signal from the wearable remote control device 130c. In that regard, the audio playback device 110 may utilize Bluetooth low energy (Bluetooth LE) proximity sensing for detection of the wearable remote control device 130c.

In response to detecting the presence of the wearable remote control device 130c near the audio playback device 110, the audio playback device 110 initiates playback of audio content. In that regard, the audio playback device 110 requests (224) an audio stream from the audio source 120. For example, the audio playback device 110 may request streamed audio from a particular entity associated with the audio source 120. The request could, for example, include or consist of an identification of a URL for an entity (e.g., a radio stream). The audio source 120 receives the request (226) and streams the requested audio content (228) (i.e., from an entity associated with the audio source 120) to the audio playback device 110.

The audio playback device receives the streamed audio content (230) and then renders (232) the audio content for the user to hear. In some cases, the audio playback device 110 may request the audio stream from the audio source 120 last accessed by the audio playback device 110. That is, if the user had previously listened to an Internet radio station via the audio playback device 110, then the audio playback device 110 may automatically access that same Internet radio station when it later detects the presence of the wearable remote control device 130c.

Alternatively, the user may be able to define rules, e.g., via the network control devices 130a, 130b, regarding what the audio playback device 110 is to play when it detects the presence of the wearable remote control device 130c. In some cases, the particular source 120 that the audio playback device 110 streams from may be made dependent on the time of day. For example, the user may decide that she wants the audio playback device 110, upon detecting the presence of the wearable remote control device 130c in proximity to the audio playback device 110, to play audio streamed from a particular Internet radio station in the morning, and that she wants the audio playback device to play audio content from a user-defined playlist of digital music streamed from an NAS device in the afternoon. Alternatively, the audio content that the audio playback device 110 renders may be based on information accumulated by the server 140 over time based on usage, e.g., what the user listens to at certain times of the day.

If the user has a plurality of audio playback devices 110 arranged in different rooms within her home, then the content played by each audio playback device 110 in response to detecting the presence of the wearable remote control device 130c may be different depending on the room in which the audio playback device 110 is located. For example, the user may have a first audio playback device 110 that is located in the user's bathroom play content from a first Internet radio station when the user walks into the bathroom, and the user may have a second audio playback device 110 that is located in the user's kitchen play a different, second Internet radio station when the user walks into the kitchen.

The wearable remote control device 130c is moved relative to the audio playback device 100, and, at step 234, the audio playback device 110 detects the change in proximity of the wearable remote control device 130c. In response to the detected change, the audio playback device 110 automatically adjusts the volume of the rendered audio content (236). For example, once the audio playback device detects the presence of the wearable remote control device 130c and initiates the playback (rendering) of audio content, the audio playback device 110 may increase the volume of audio content being played on the audio playback device 110 when the wearable remote control device 130c is moved closer to the audio playback device 110.

The audio playback device 110 may determine the proximity of the wearable remote control device 130c based on a strength of a signal received from the wearable remote control device 130c, and may gradually adjust the volume based on the signal strength, e.g., increase the volume as the signal strength increases. This volume increase may be limited to certain ranges. For example, the volume may be increased only until the strength of the signal from the wearable remote control device 130c reaches a threshold value and may remain constant, absent user intervention, while the signal strength remains above that threshold value.

Likewise, the audio playback device 110 may decrease the volume of audio content being played on the audio playback device 110 when the wearable remote control device 130c is moved away from the audio playback device 110. For example, the audio playback device 110 may gradually reduce the volume of content being played as the strength of the signal from the wearable remote control device 130c decreases. This volume decrease may be limited to certain ranges. For example, the volume may be decreased only when the strength of the signal from the wearable remote control device 130c falls below a first threshold value and may remain constant, absent user intervention, while the signal strength remains above that first threshold value.

The audio playback device 110 may also cease playing audio content and enter a standby mode (240) when the audio playback device 110 detects a loss of the signal from the wearable remote control device (238), e.g., when the signal strength drops below a second threshold value, indicating that the wearable remote control device has been moved out of range of the audio playback device 110.

Transitioning Audio

Proximity detection can also be utilized to allow for the transition of audio content from one audio playback device 110 to another audio playback device 110 within the system 100. So, for example, a user wearing the wearable remote control device 130c and listening to audio content being played by a first audio playback device 110 in a first location (e.g., the user's bedroom) may decide to move to a second location (e.g., the user's kitchen) and the audio content could follow the user and automatically begin playing on a second audio playback device 110 when the user arrives at the second location.

This can be achieved by storing information about recently played audio content on the wearable remote control device 130c. The information could include, for example, identification of the most recently accessed entity. This information could be provided to the wearable remote control device 130c from the audio playback device that played the audio content. Then, as the user, wearing the wearable remote control device 130c, moves away from the first audio playback device 110 and toward a second audio playback device 110, the second audio playback device 110, upon detecting the presence of the wearable remote control device, could request the information regarding the recently played audio content and it may then playback audio content from the same source 120. This allows the audio content to seemingly follow the user as the user moves between different locations where different audio playback devices 110 are located.

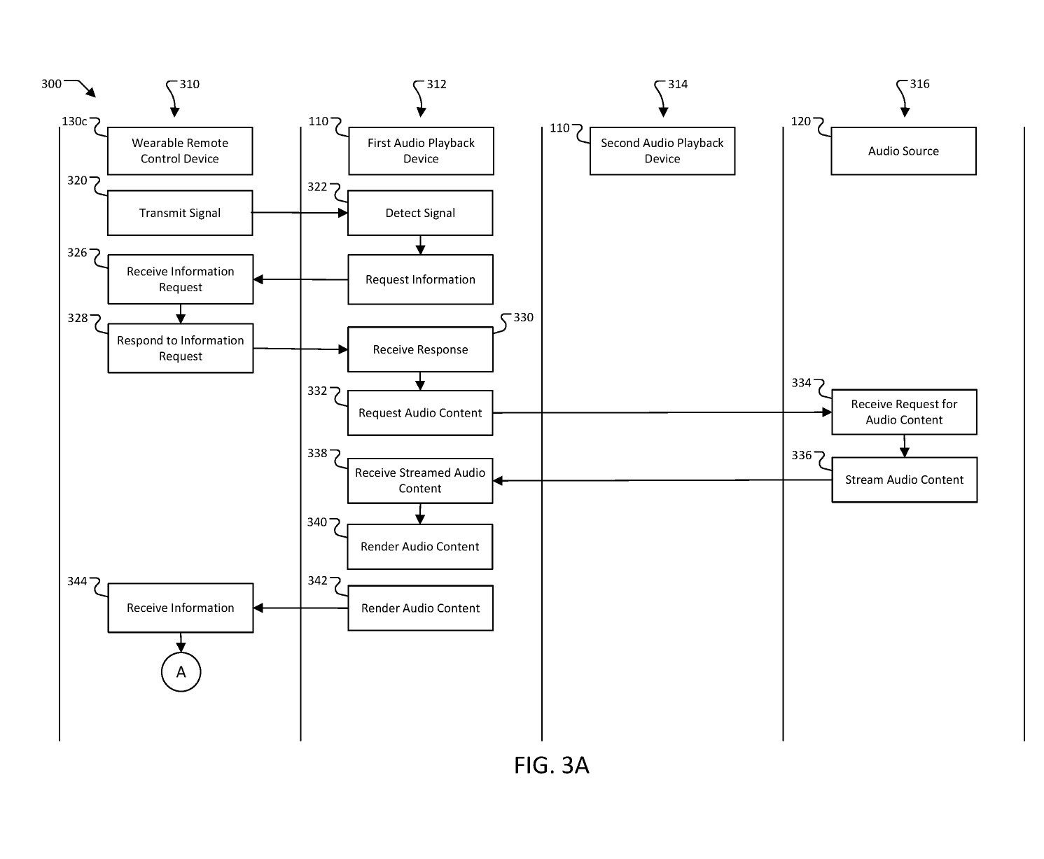

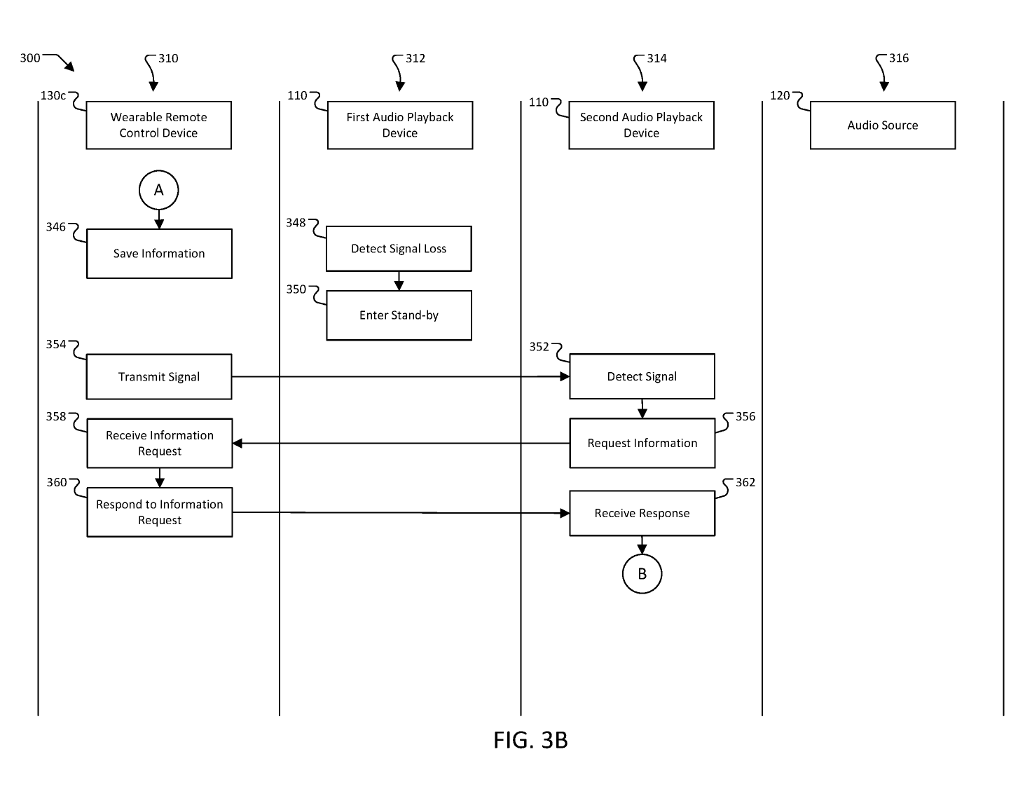

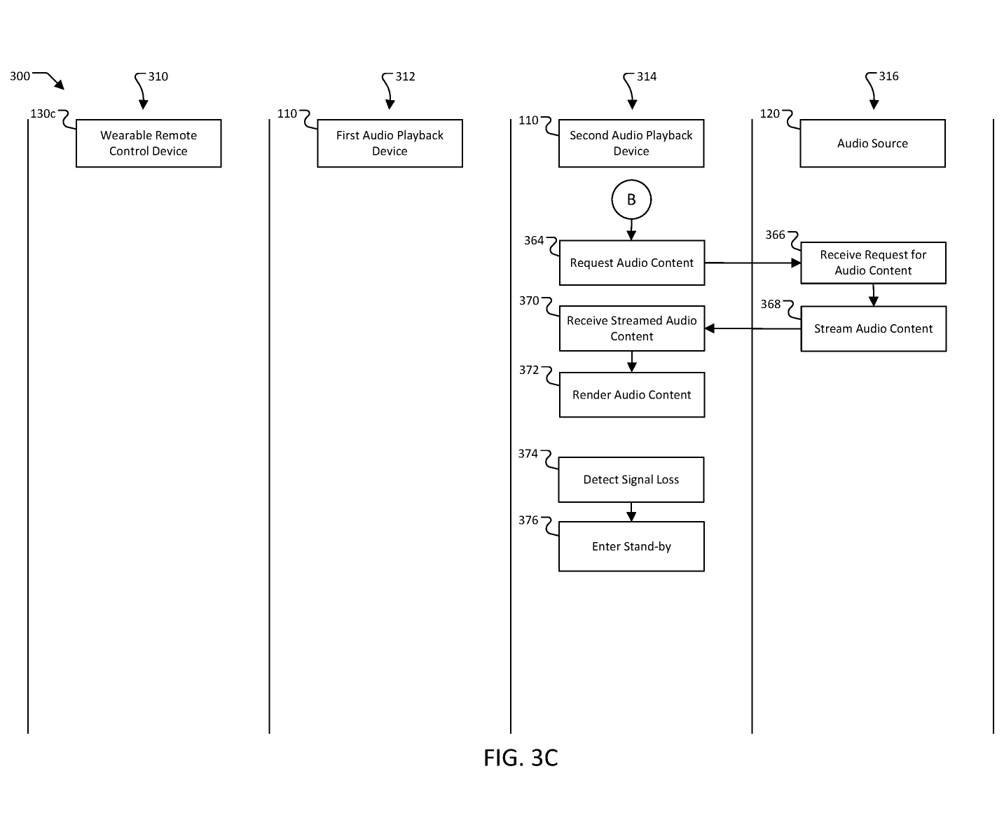

FIGS. 3A through 3C illustrate a swim lane diagram 300 illustrating steps for transitioning audio content between audio playback devices. Four swim lanes are shown including a lane 310 for the wearable remote control device 130c, a lane 312 for a first one of the audio playback devices (hereinafter the first audio playback device 110), a lane 314 for a second one of the audio playback devices (hereinafter the second audio playback device 110), and a lane 316 for one of the audio sources 120.

At step 320, the wearable remote control device 130c transmits a signal which is detected, at step 322, by the first audio playback device 110 which may initially be in a stand-by (low power) mode. At step 324, in response to detecting the presence of the wearable remote control device 130c, the first audio playback device 110 requests information from the wearable remote control device 130c regarding recently played audio content.

At step 326, the wearable remote control device 130c receives the request for information from the first audio playback device 110, and, at step 328, the wearable remote control device 130 sends a response to the first audio playback device 110. If the wearable remote control device 130c has information regarding recently played audio content, then the wearable remote control device 130c provides that information in the response to the first audio playback device 110.

In this example, no information is initially available, so the wearable remote control device 130c provides an indication to the first audio playback device 110 that no information is available. When no information is available from the wearable remote control device 130c, then the first audio playback device 110 may rely on a default setting or predefined rules to determine which audio source/entity to access when initiating playback of audio content in response to detecting the wearable remote control device 130c.

At step 330, the first audio playback device receives the response, and, in response, the first audio playback device 110 requests streamed audio content from the audio source 120 at step 332. The request may include a request for streamed content from a particular entity associated with the audio source 120. At step 334, the audio source 120 receives the request for audio content, and, in response, the audio source 120 streams the requested audio content to the first audio playback device 110 at step 336. The request could, for example, include or consist of an identification of a URL for an entity (e.g., a radio stream). The first audio playback device receives the streamed audio content from the source, and, at step 340, the first audio playback device 110 renders the audio content.

The first audio playback device 110 also provides the wearable remote control device with information regarding the streamed audio content (342). This information can include, for example, an identification of the source 120 and/or the associated entity providing the audio content. At step 344, the wearable remote control device 130c receives the information regarding the audio content being rendered, and, at step 346, the wearable remote control device 130c stores the information in memory. The first audio playback device 110 will send updated information each time a different entity is selected.

The wearable remote control device 130c is then moved away from the first audio playback device 110, e.g., as the user wearing the wearable remote control device 130c walks from one location (e.g., a first room) to a second location (e.g., a second room). At step 348, the first audio playback device 110 detects a loss in the signal from the wearable remote control device 130c, and, in response, enters a stand-by mode (350) in which it ceases playing the audio content. In some cases, the first audio playback device 110 may gradually reduce the volume of audio content rendered via the first audio playback device 110 as the wearable remote control device 130c is moved away from the first audio playback device 110 until the strength of the signal from the wearable remote control device 130c drops below a threshold value, at which point it would enter the stand-by mode.

As the user, wearing the wearable remote control device 130c, approaches the second audio playback device 100, the second audio playback device 110 detects (352) the presence of the wearable remote control device 130c by detecting the signal transmitted (354) by the wearable remote control device 130c. In response to detecting the presence of the wearable remote control device 130c, the second audio playback device 110 requests information (356) from the wearable remote control device 130c regarding recently played audio content.

In this example, the wearable remote control device 130c now has the information regarding the recently played content that was provided from the first audio playback device 110. At step 360, the wearable remote control device 130c provides a response with the information regarding the recently played content to the second audio playback device 110. At step 362, receives the requested information, and, then utilizes that information to identify the source for the audio content.

At step 364, based on the information provided from the wearable remote control device 130c, the second audio playback device 110 requests streamed audio content from the same audio source 120 that had been previously providing stream audio content to the first audio playback device 110. The audio source 120 receives the request (366) and provides (streams) the requested audio content (368).

At step 370, the second audio playback device 130c receives the streamed audio content, and, then, renders (372) the audio content for the user. This can give the user the impression that the audio content has followed them from the location of the first audio playback device 110 to the location of the second audio playback device 130c. In some cases, the second audio playback device 110 may gradually increase the volume of audio content rendered via the second audio playback device 110 as the wearable remote control device 130c is moved closer to the second audio playback device 110.

If a new entity is selected, either through the wearable remote control device 130c itself or through user interaction with one of the audio playback devices 110, the information stored on the wearable remote control device 130c will be updated, via communication with the audio playback device, to reflect the change.

If the user later moves away from the second audio playback device 110, then the second audio playback device 110 will detect a loss in the signal (374) from the wearable remote control device 130c and enter a stand-by mode (376) in which it ceases playing the audio content. In some cases, the second audio playback device 110 may gradually reduce the volume of audio content rendered via the second audio playback device 110 as the wearable remote control device 130c is moved away from the second audio playback device 110 until the strength of the signal from the wearable remote control device 130c drops below a threshold value, at which point it would enter the stand-by mode.

In some implementations, the second audio playback device 110 may be a head unit in a user's automobile. The head units can communicate with the wearable remote control device 130c via Bluetooth LE and with the audio source 120 via a mobile telecommunications technology such as 4G. This can allow for audio content to follow the user from the user's home into the user's car.

Voice Control

In some cases, the system may also provide voice control functionality.

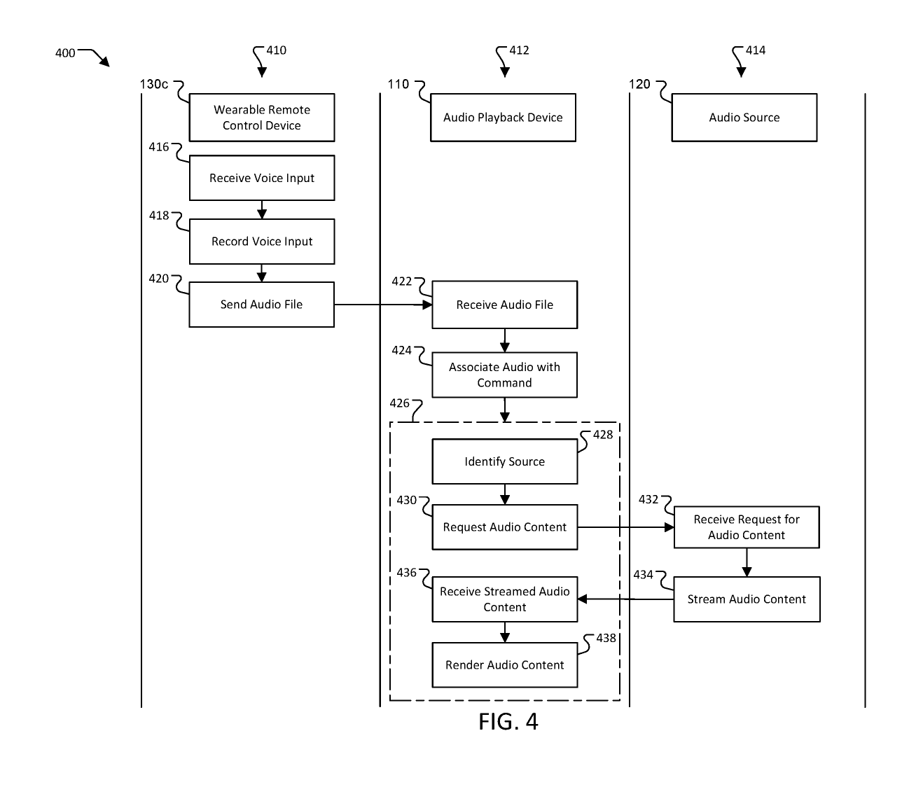

FIG. 4 is a swim lane diagram 400 illustrating steps for voice control within the system 100. Three swim lanes are shown including a lane 410 for the wearable remote control device 130c, a lane 412 for one of the audio playback devices 110, and a lane 414 for one of the audio sources 120.

At step 416, the wearable remote control device 130c receives voice input, via one more microphones, and records the voice input (418) in an audio file. At step 420, the wearable remote control device 130c sends the audio file to an associated (paired) one of the audio playback devices 110, which may be the audio playback device 110 closest to the wearable remote control device 130c. At step 422, the audio playback device 110 receives the audio file and runs the recorded audio through a speech recognition algorithm in order to associate the recorded audio with a command (424). Then the audio playback device executes the associated command (426).

The recorded audio may be a command to play content from a particular music genre or artist. For example, the recorded audio may be “Play Rush,” which the audio playback device would associate with a command to play audio content by artist Rush. In response, the audio playback device identifies a source (and an associated entity) to provide streamed audio content that is pertinent to the command (428). This may begin with a search of content available on the user's LAN, and, if the search of the local content does not produce results, then the audio playback device 110 can extend the search to remote audio sources.

Once a source 120 with an appropriate entity for providing relevant content is identified, the audio playback device 110 will request streamed audio content from the source 120 (430). The request could, for example, include or consist of an identification of a URL for an entity (e.g., a radio stream). In some cases, the audio playback device 110 may use the name of the requested artist or a requested song to seed a personal radio station via an automated music recommendation service, such as Pandora Radio.

At step 432, the source 120 receives the request, and, in response, provides (streams) the requested audio content (434) to the audio playback device 110. The audio playback device 110 receives the streamed audio content at step 436, and, at step 438, the audio playback device 110 renders the audio content which is relevant to the user's command.

Gesture Recognition

In some cases, the wearable remote control device 130c may also provide gesture recognition functionality.

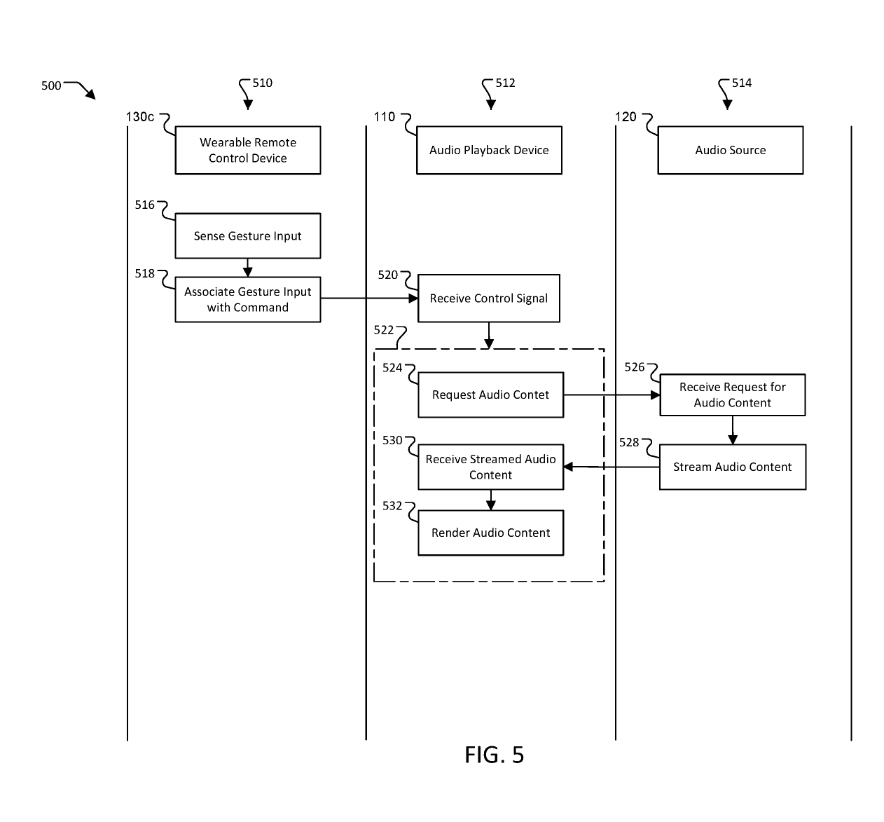

FIG. 5 is a swim lane diagram 500 illustrating steps for gesture recognition functionality. Three swim lanes are shown including a lane 510 for the wearable remote control device 130c, a lane 512 for one of the audio playback devices 110, and a lane 514 for one of the audio sources 120.

At step 516, the wearable remote control device 130c senses gesture input from a user. The gesture input may include a pattern, such as a numeral or letter, traced by the user. In this regard, the wearable remote control device 130c may include a user interface with a touch surface and sensors for sensing a pattern traced by the user's finger on the touch surface. Alternatively or additionally, the wearable remote control device 130c could include sensors for sensing acceleration and orientation of the wearable remote control device, such as an accelerometer and a gyroscope. Such acceleration and orientation sensors can be used to sense gestures based on movement of the user's arm while the user is wearing the wearable remote control device and tracing a pattern in the air or on a surface that is not part of the wearable remote control device, such as a desk or table.

At step 518, the wearable remote control device 130c uses a gesture recognition algorithm to associate the gesture input with a command. Then, the wearable remote control device 130c sends a control signal to the audio playback device 110. The audio playback device 110 receives the control signal (520) and executes the associated command (522).

For example, the gesture input may be a number “1” traced on a touch surface of the wearable remote control by the user. The wearable remote control device 130c might associate this gesture input with a request to play audio content from preset “1” on the audio playback device, and, in response, will send a command signal to the audio playback device to cause the audio playback device. In the illustrated example, the audio playback device 110 receives the control signal (520), and, in response, requests audio content (524) from the source 120. The request could, for example, include or consist of an identification of a URL for an entity (e.g., a radio stream). The audio content being provided from a particular entity that is associated with the audio and which is assigned to preset “1” on the audio playback device. For example, the audio source 120 may be an Internet radio service, and the entity may be a particular internet radio station that is available for streaming from the audio source.

At step 526, the audio source receives the request (526), and, at step 528, the audio source 120 streams the requested audio content to the audio playback device 110. The audio playback device 110 receives (530) and renders (532) the streamed audio content.

Audio Through Wearable

In some cases, the wearable remote control device may give the user the option to have audio content streamed directly to the wearable remote control device for rending.

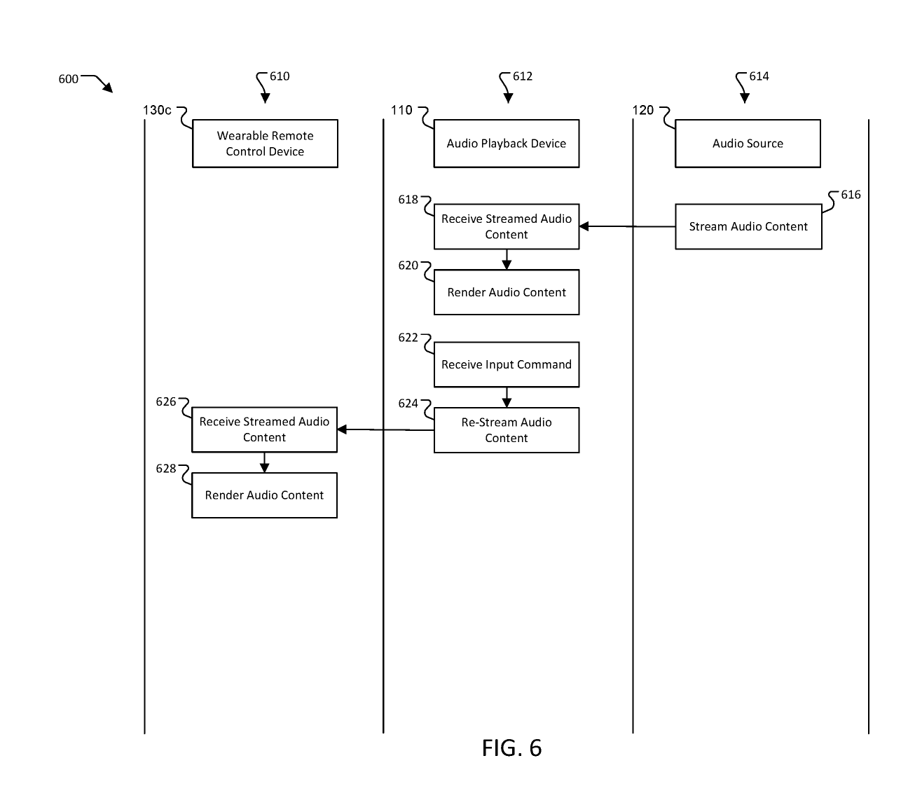

FIG. 6 is a swim lane diagram 600 illustrating steps for the streaming of audio content to the wearable remote control device. Three swim lanes are shown including a lane 610 for the wearable remote control device 130c, a lane 612 for one of the audio playback devices 110, and a lane 614 for one of the audio sources 120.

At step 616, the audio source streams audio content (e.g., music) to the audio playback device. The audio playback device 110 receives (618) and renders (620) the streamed audio content received from an audio source. At step 622, the audio playback device 110, which is in communication (paired) with the wearable remote control device 130c, receives an input command to stream audio to the wearable remote control device 130c. In response to receiving the input command, the audio playback device 110 re-streams (624), e.g., via Bluetooth wireless technology, the audio content received from the source to the wearable remote control device 130c. The wearable remote control device 130c receives the audio content, and renders the audio content via one or more speakers located on the wearable remote control device 130c.

This may allow the user to carry their music with them, e.g., as they venture out into their yard, so long as they remain in transmission range of the audio playback device 110. In some cases, the audio playback device 110 may automatically mute itself when it is streaming audio content to the wearable remote control device 130c so that audio is not playing needlessly on the audio playback device 110 when the user is instead listening through the wearable remote control device 130c.

Audio Playback Devices

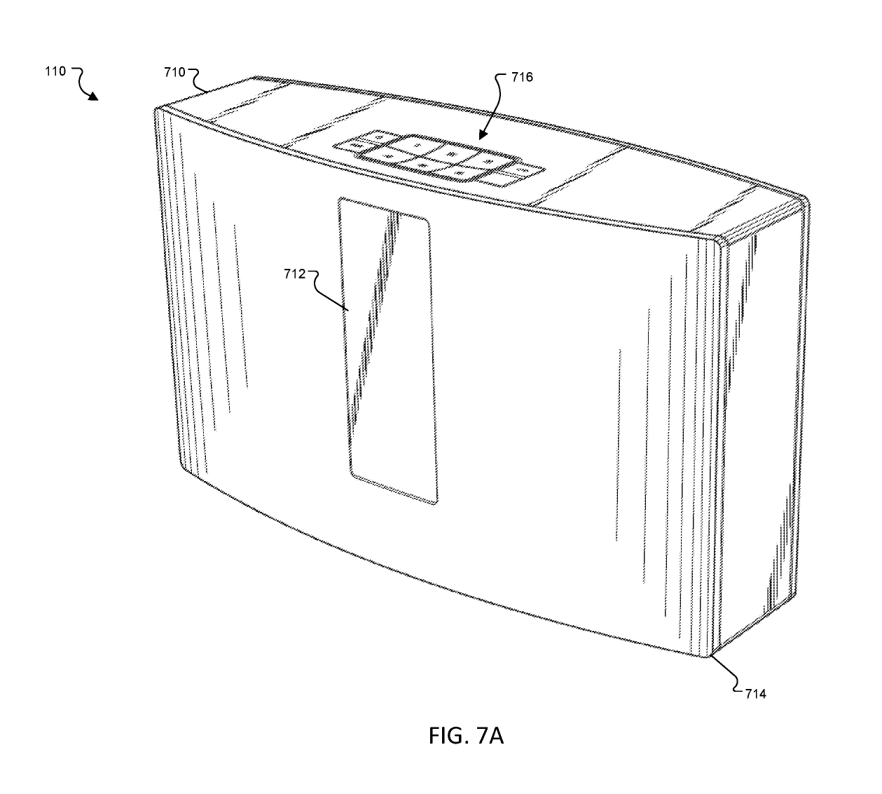

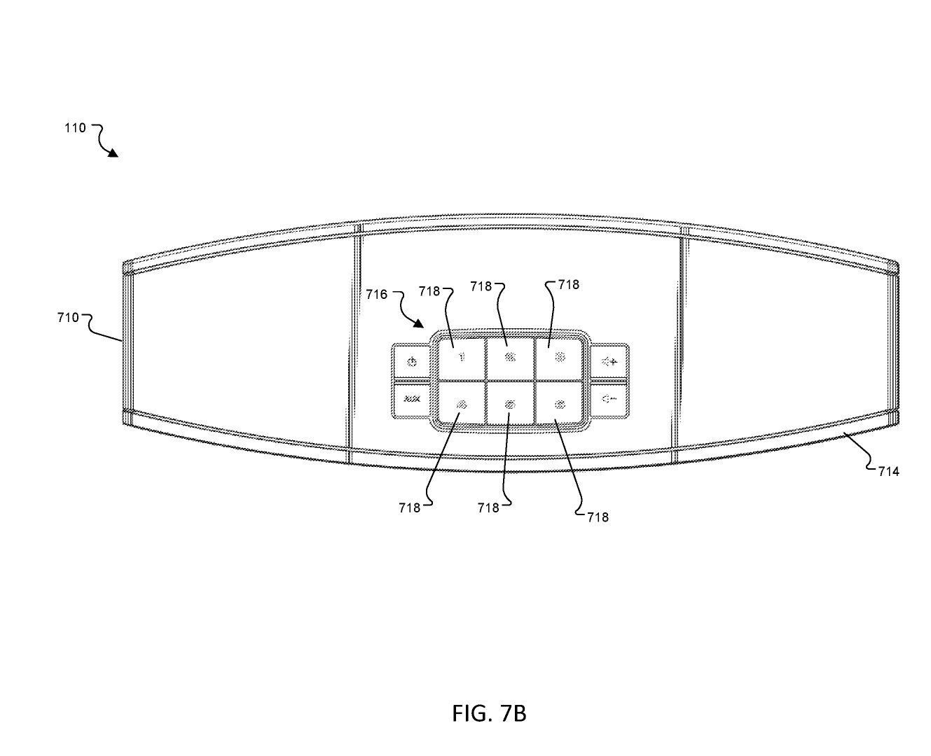

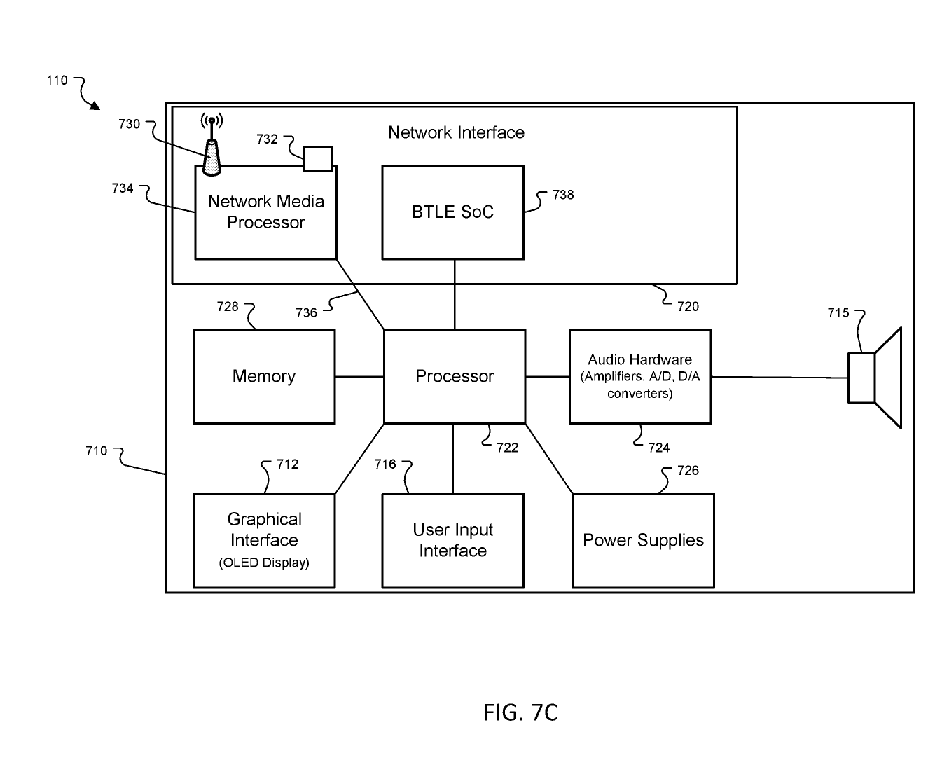

An exemplary audio playback device 110 will now be described in greater detail with reference to FIGS. 7A through 7C. Referring to FIG. 7A, an audio playback device 110 includes an enclosure 710 and on the enclosure 710 there resides a graphical interface 712 (e.g., an OLED display) which can provide the user with information regarding currently playing (“Now Playing”) music and information regarding presets.

A screen 714 conceals one or more electro-acoustic transducers 715 (FIG. 7C). The audio playback device 110 also includes a user input interface 716. As shown in FIG. 7B, the user input interface 716 includes a plurality of preset indicators 718, which are hardware buttons in the illustrated example. The preset indicators 718 (numbered 1-6) provide the user with easy, one press access to entities assigned to those buttons. That is, a single press of a selected one of the preset indicators 718 will initiate streaming and rendering of content from the assigned entity.

The assigned entities can be associated with different ones of the digital audio sources (items 120a, 120b, 120c, FIG. 1) such that a single audio playback device 110 can provide for single press access to various different digital audio sources. In one example, the assigned entities include at least (i) user-defined playlists of digital music and (ii) Internet radio stations. In another example, the digital audio sources include a plurality of Internet radio sites, and the assigned entities include individual radio stations provided by those Internet radio sites.

With reference to FIG. 7C, the audio playback device 110 also includes a network interface 720, a processor 722, audio hardware 724, power supplies 726 for powering the various audio playback device components, and memory 728. Each of the processor 722, the graphical interface 712, the network interface 720, the audio hardware 724, the power supplies 726, and the memory 728 are interconnected using various buses, and several of the components may be mounted on a common motherboard or in other manners as appropriate.

The network interface 720 provides for communication between the audio playback device 110 and the control devices (e.g., items 130a-c, FIG. 1), the server (item 140, FIG. 1), the audio sources (items 120, FIG. 1) and other audio playback devices 110 via one or more communications protocols. The network interface 720 may provide either or both of a wireless interface 730 and a wired interface 732. The wireless interface 730 allows the audio playback device 110 to communicate wirelessly with other devices in accordance with a communication protocol such as such as IEEE 802.11 b/g. The wired interface 732 provides network interface functions via a wired (e.g., Ethernet) connection.

In some cases, the network interface 720 may also include a network media processor 734 for supporting Apple AirPlay® (a proprietary protocol stack/suite developed by Apple Inc., with headquarters in Cupertino, Calif., that allows wireless streaming of audio, video, and photos, together with related metadata between devices). For example, if a user connects an AirPlay® enabled device, such as an iPhone or iPad device, to the LAN 150, the user can then stream music to the network connected audio playback devices 110 via Apple AirPlay®. A suitable network media processor is the DM870 processor available from SMSC of Hauppauge, N.Y. The network media processor 734 provides network access (i.e., the Wi-Fi network and/or Ethernet connection can be provided through the network media processor 734) and AirPlay® audio. AirPlay® audio signals are passed to the processor 722, using the I2S protocol (an electrical serial bus interface standard used for connecting digital audio devices), for downstream processing and playback. Notably, the audio playback device 110 can support audio-streaming via AirPlay® and/or DLNA's UPnP protocols, and all integrated within one device.

All other digital audio coming from network packets comes straight from the network media processor 734 through a USB bridge 736 to the processor 722 and runs into the decoders, DSP, and eventually is played back (rendered) via the electro-acoustic transducer(s) 715.

The network interface 710 can also include a Bluetooth low energy (BTLE) system-on-chip (SoC) 738 for Bluetooth low energy applications (e.g., for wireless communication with the wireless remote control device (item 130c, FIG. 1)). A suitable BTLE SoC is the CC2540 available from Texas Instruments, with headquarters in Dallas, Tex.

Streamed data pass from the network interface 720 to the processor 722. The processor 722 can execute instructions within the audio playback device (e.g., for performing, among other things, digital signal processing, decoding, and equalization functions), including instructions stored in the memory 728. The processor 722 may be implemented as a chipset of chips that include separate and multiple analog and digital processors. The processor 722 may provide, for example, for coordination of other components of the audio playback device 110, such as control of user interfaces, applications run by the audio playback device 110. A suitable processor is the DA921 available from Texas Instruments.

The processor 722 provides a processed digital audio signal to the audio hardware 724 which includes one or more digital-to-analog (D/A) converters for converting the digital audio signal to an analog audio signal. The audio hardware 724 also includes one or more amplifiers which provide amplified analog audio signals to the electroacoustic transducer(s) 715 for playback. In addition, the audio hardware 724 may include circuitry for processing analog input signals to provide digital audio signals for sharing with other devices in the acoustic system 100.

The memory 728 stores information within the audio playback device 110. In this regard, the memory 728 may store account information, such as the preset information discussed above.

The memory 728 may include, for example, flash memory and/or non-volatile random access memory (NVRAM). In some implementations, instructions (e.g., software) are stored in an information carrier. The instructions, when executed by one or more processing devices (e.g., the processor 722), perform one or more processes, such as those described above (e.g., with respect to FIGS. 2, 3, 4, 5, and 6). The instructions can also be stored by one or more storage devices, such as one or more computer- or machine-readable mediums (for example, the memory 728, or memory on the processor). The instructions may include instructions for performing decoding (i.e., the software modules include the audio codecs for decoding the digital audio streams), as well as digital signal processing and equalization.

Wearable Remote Control Device

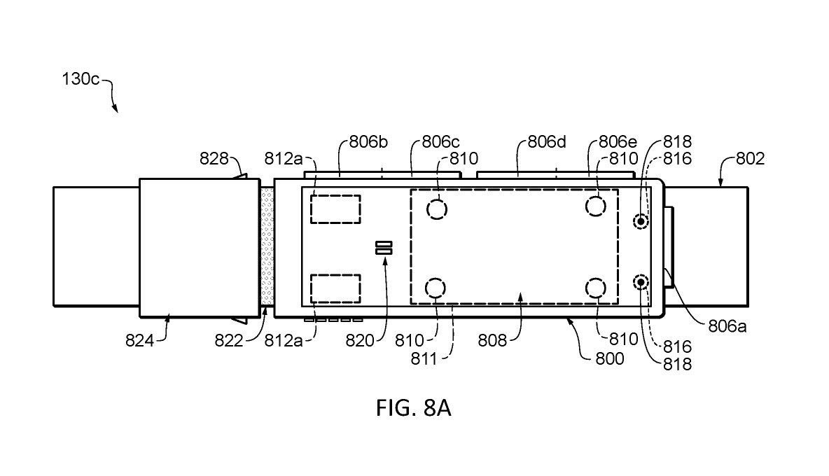

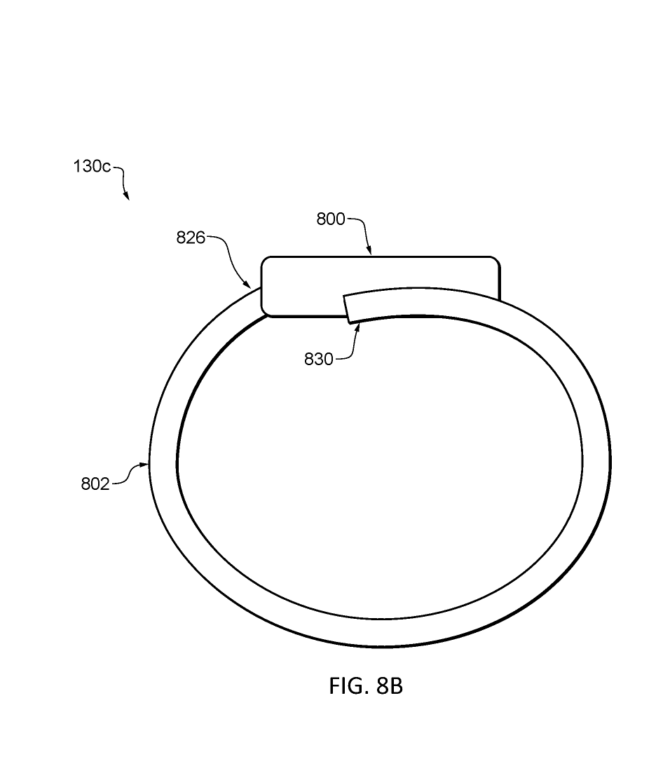

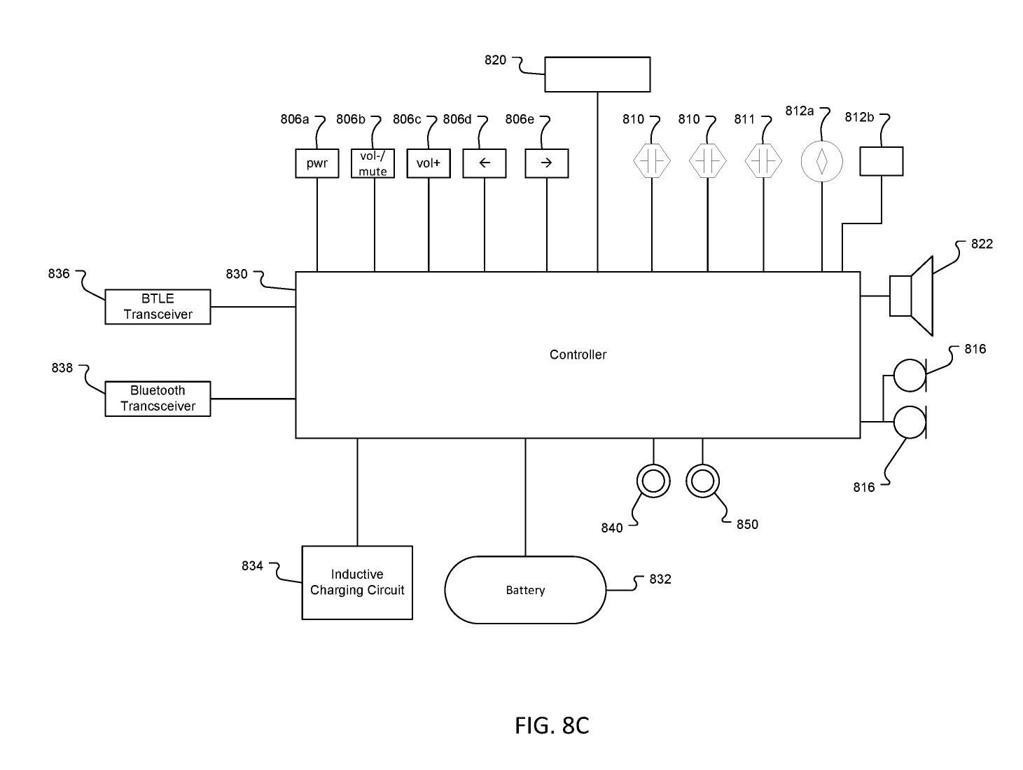

With reference to FIGS. 8A and 8B, the wearable remote control device 130c is configured to be worn around a user's wrist. The wearable remote control device 130c includes an electronic module 800 and a band 802. The electronic module 800 includes a user interface with a series of buttons 806a-e along a peripheral surface of the electronic module 800 which can be used to control operation of an associated (paired) audio playback device 110. Referring to FIG. 8A, a “power” button 806a is pressed to turn an associated (paired) audio playback device 110 on or off. A “vol−/mute” button 806b can be pressed to decrease the volume on and mute the associated audio playback device 110. A “vol+” button 806c is pressed to increase the volume of the associated audio playback device 100. A “←” button 806d and a “→” button 806e provide the ability to navigate content (previous, next).

The electronic module 800 is also configured to sense gesture and tap input. In this regard, the user interface may include a touch surface 808 and a plurality of force sensors 810 for detecting the gesture or tap input by sensing localized displacement of the touch surface 808.

The gesture input can include a pattern (e.g., a letter, number, or symbol) traced, by the user's finger, on the touch surface. For example, in some cases, the user may trace a number from 1 to 6 to select a preset for playback on the audio playback device 110. In some cases, the traced pattern may take the form of a straight line swipe. For example, a left-to-right swipe may cause the associated audio playback device 110 to skip to the next song or audio track, and a right-to-left swipe may cause the associated audio playback device 110 to skip back to a previous song or audio track.

The touch surface 808 can also be utilized for receiving tap input. For example, a single tap may cause the associated audio playback device 110 to play or pause playback of audio content on the associated audio playback device 110. Two taps in quick succession can activate the voice control functionality of the wearable remote control device 130c.

Alternative or additionally, the electronic module 800 may include a capacitive sensor 811 for detecting the gesture and tap input by sensing changes in capacitance when a user touches the touch surface 808

The electronic module 800 can include orientation and acceleration sensors (e.g., a gyroscope 812a and an accelerometer 812b) for sensing movements of the wearable remote control device 130c. The orientation and acceleration sensors 812a, 812b can be utilized to sense gesture input based on movements of the wearable remote control device 110. That is, the when the user is wearing the wearable remote control device 110 on their wrist, the orientation and acceleration sensors 812a, 812b can be used to sense a pattern traced in the air, or on a surface such as a desk or wall, by the user's hand based on the movements of the wearable remote control device 110.

Input from the orientation and acceleration sensors 812a, 812b could also be used to detect when the wearable remote control device 130c is shaken. The shaking of the wearable remote control device may activate a feature. For example, the wearable remote control device 130c can be configured to enter a pairing mode when it is shaken. In the pairing mode, the wearable remote control device 130c is discoverable by the audio playback device 110. To complete the pairing, a pair button on the audio playback device 110 may then be pressed to pair with the discoverable wearable remote control device 130c.

The electronic module 800 can also include one or more microphones 816 (two shown) for receiving speech/voice input from the user to enable the voice control functionality discussed above. In the illustrated example, the microphones 816 are positioned beneath the touch surface 808, and the touch surface 808 includes apertures 818 which allow the microphones to pick up the user's voice input.

The electronic module 800 may also include a stator indicator 820 for providing the user with a visual indication of the status (e.g., play/pause) of audio content rendered on the associated audio playback device 110. The status indicator 820 may be implemented as back lit icons or an LED display.

The electronic module 800 also includes an electro-acoustic transducer 822 for rendering audio content streamed to the wearable remote control device 130c from the associated audio playback device.

A connector 824 connects the electronic module 800 to a first end 826 of the band 802. The connector 824 includes a latch 828 that can be released to separate the electronic module 800 from the band 802. As shown in FIG. 8B, a second, free end 830 of the band 802 wraps underneath the electronic module 800. In that regard, the band 802 could have a bias on it so it coils around the user's wrist without having to connect to the electronic module at both ends.

With reference to FIG. 8C, a controller 830 (e.g., a microprocessor) controls operation of the wearable remote control device 130c. Buttons 806a-e provide inputs to the controller 830 for the specific functions that each controls. Force sensors 810 provide input to the controller 830 for sensing gesture and tap input based on localized displacement of the touch surface. Alternatively or additionally, a capacitive sensor 811 can be utilized to provide input to the controller 830 for sensing gesture and tap input based on changes in capacitance along the touch surface. Alternatively or additionally, a gyroscope 812a and an accelerometer 812b can be utilized to provide input to the controller 830 for sensing gesture and tap input based on detected movements of the wearable remote control device 130c.

A battery 832 provides electrical power to the controller 830. An inductive charging circuit 834 may be provided for charging the battery 832. Alternatively or additionally, a charging jack 835 may be provided for electrically charging the battery 832.

A Bluetooth Low Energy (BTLE) transceiver 836 (comprising a transmitter and a receiver) is provided for communicating with an associated audio playback device 110. For example, the BTLE transceiver 836 can be used for transmitting control signals and signals for proximity detection. Wireless audio signals can be received by a Bluetooth transceiver 838 (comprising a transmitter and a receiver) and passed to the controller 830 in digital form. The controller 830 may perform some digital signal processing on the audio signals and convert the signals to an analog form via a digital-to-analog (D/A) converter. An amplifier on the controller 830 amplifies the analog signals which are then passed to the electro-acoustic transducer 822 to create sound. A headphone jack 840 may be provided for private listening.

The electronic module 800 also includes memory 842 for storing instructions, which when executed by one or more processing devices (e.g., the processor 722), perform one or more processes, such as those described above (e.g., with respect to FIGS. 2, 3, 4, 5, and 6). The memory 842 may include a combination of volatile memory for volatile data storage, such as cache, and non-volatile memory for storing program instructions.

Other Implementations

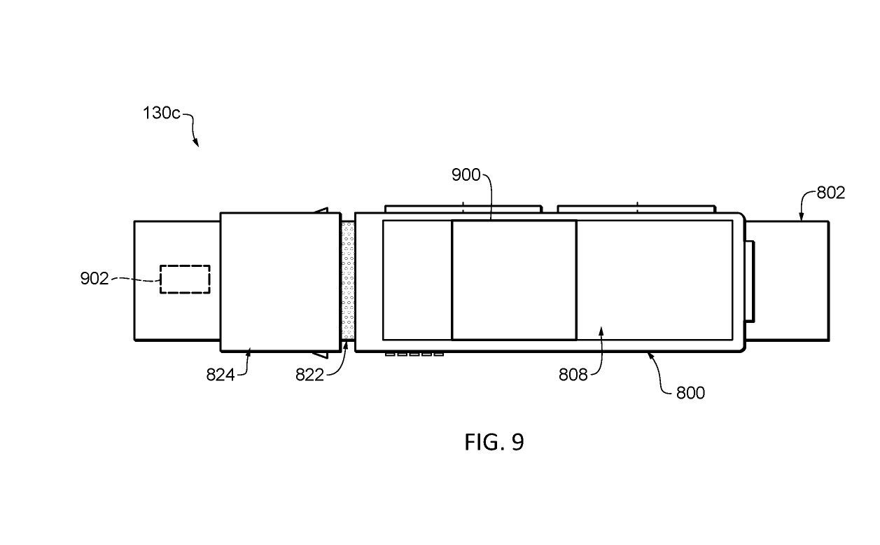

With reference to FIG. 9, in some implementations, the wearable remote control device 130c may include a display 900 (e.g., an OLED display) to provide the user with visual feedback. In some cases, a touch screen can be utilized to provide visual feedback as well a touch surface for gesture and tap input.

In certain implementations, the band 802 may include memory 902 with instructions for controlling the display 900. In that regard, the connector 824 may comprise a microUSB connector for placing the memory 902 in communication with the controller 830 (FIG. 8C). The controller 830 could read the instructions from the memory 902 on the band 802 and controlling visual output (“skins”) on the display 900 based on the instructions. This can allow the display 900 to be changed based on the band 802. For example, the style of the display 900 may be changed to match that of the band 802.

In some cases, the audio system may provide for alarm clock functionality.

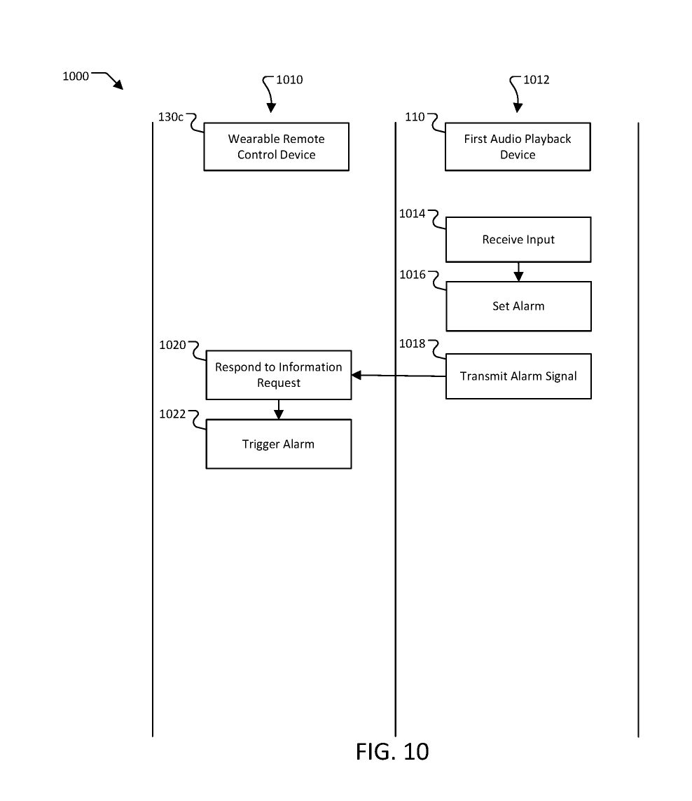

FIG. 10 is a swim lane diagram 1000 illustrating steps for the alarm clock functionality. Two swim lanes are shown including a lane 1010 for the wearable remote control device 130c and a lane 1012 for an audio playback device 110.

At step 1014, the audio playback device 110 receives input corresponding to a command to set an alarm to go off at a specified time. The input may be in the form of a voice command received from the wearable remote control device 130c, e.g., “wake me at 6 am.” At step 1016, the audio playback device 110 sets alarm to go off at the specified time.

At the specified time, as determined based on an internal clock of the audio playback device 110, the audio playback device 110 transmits (via the BTLE connection) an alarm signal to the wearable remote control device 130c (1018). At step 1020, the wearable remote control device 130c receives the alarm signal, and, in response, triggers an alarm (1022). In some cases, the alarm may be an audible alarm produced through the electro-acoustic transducer 822. Alternative, the alarm can be a vibrating alarm produced by vibrating motor 850 (FIG. 8C) in the wearable remote control device 130c. A vibrating alarm can be beneficial for alerting (e.g., waking) the user without disturbing others.

In some cases, the wearable remote control device 130c may be paired with a mobile phone and provide a telephony connection.

A number of implementations have been described. Nevertheless, it will be understood that additional modifications may be made without departing from the scope of the inventive concepts described herein, and, accordingly, other embodiments are within the scope of the following claims.

1-15. (canceled)

16. A wearable remote control device for controlling operation of an audio playback device, the wearable remote control device comprising:
a transmitter;
one or more sensors;
a controller; and
instructions stored on a non-transitory computer-readable media that, when executed, cause the controller to:
detect gesture input from a user via the one or more sensors, the gesture input comprising a number traced by the user, where the number corresponds to that of a preset indicator on an audio playback device;
associate the gesture input with a command to play audio content from an entity associated with the preset indicator; and
send a command signal to the audio playback device via the transmitter to cause the audio playback device to render the audio content from the entity associated with the preset indicator.

17. The wearable remote control device of claim 16, further comprising a touch surface, wherein the gesture input comprises a pattern traces on the touch surface.

18. The wearable remote control device of claim 17, wherein the one or more sensors comprise a plurality of force sensors, and wherein the instructions cause the controller to detect the gesture input by sensing localized displacement of the touch surface.

19. The wearable remote control device of claim 17, wherein the one more sensors comprise a capacitive sensor, and wherein the instructions cause the controller to detect the gesture input by sensing changes in capacitance as a user traces a pattern on the touch surface.

20. The wearable remote control device of claim 16, wherein the one or more sensors comprise an orientation sensor and an acceleration sensor, and wherein the instructions cause the controller to detect the gesture input by sensing movements of the wearable remote control device via the orientation and acceleration sensors.

21-28. (canceled)

29. The wearable remote control device of claim 20, wherein the acceleration and orientation sensors are configured to sense gestures based on movement of the user's arm while the user is wearing the wearable remote control device and tracing a pattern in the air or on a surface that is not part of the wearable remote control device.

30. An audio system comprising:
A.) an audio playback device configured to operably connect to a plurality of digital audio sources, the audio playback device comprising:
i.) a digital-to-analog converter configured to receive a digital representation of content from the digital audio sources and convert to analog form;
ii.) an electro-acoustic transducer; and
iii.) a set of user-selectable preset indicators, wherein each indicator in the set of preset indicators is configured to have assigned to it an entity associated with the plurality of digital audio sources; and
B.) a wearable remote control device for controlling operation of the audio playback device, the wearable remote control device comprising:
i.) a transmitter;
ii.) one or more sensors;
iii.) a controller; and
iv.) instructions stored on a non-transitory computer-readable media that, when executed, cause the controller to:
a.) detect gesture input from a user via the one or more sensors, the gesture input comprising a number traced by the user, where the number corresponds to that of one of the preset indicators on an audio playback device;
b.) associate the gesture input with a command to play audio content from an entity associated with the corresponding one of the preset indicators; and
c.) send a command signal to the audio playback device via the transmitter to cause the audio playback device to render the audio content from the entity associated with the corresponding one of the preset indicators.

31. The audio system of claim 30, wherein the audio playback device further comprises an enclosure, and wherein the digital-to-analog converter and the electro-acoustic transducer are located within the enclosure and the set of user-selectable present indicators is located on the enclosure.

32. The audio system of claim 30, wherein the digital audio sources comprise at least (i) one or more libraries of user-defined playlists of digital music files and (ii) Internet radio sites.

33. The audio system of claim 30, wherein the assignable entities include at least individual Internet radio stations and particular user-defined playlists of digital music files.

34. The audio system of claim 30, wherein the set of preset indicators comprise hardware buttons.

35. The audio system of claim 30, wherein the digital audio sources include a plurality of Internet radio sites, and the entities include individual radio stations provided by the Internet radio sites.

36. The audio system of claim 30, wherein the preset indicators provide access to the respectively assigned entities in the same manner irrespective of the associated digital audio source.

37. The audio system of claim 30, wherein the preset indicators provide for single press access to the respectively assigned entities irrespective of the digital audio source.
